(19) United States
(12) Patent Application Publication
(10) Pub. No.: US 2026/0307286 A1
(43) Pub. Date: Oct. 8, 2026

(54) DEVICE AND METHOD FOR REMOVING MATERIAL FROM A MATERIAL ROLL

(71) Applicant: Core Link AB, Falkenberg (SE)

(72) Inventors: Nils STRANDH, Falkenberg (SE); Jörgen JENSEN, Falkenberg (SE); Christian WENNERBERG, Falkenberg (SE)

(21) Appl. No.: 19/543,497

(22) Filed: Feb. 18, 2026

(30) Foreign Application Priority Data
Apr. 8, 2025 (SE) 2550337-6

(51) Int. Cl. B26D 3/28; B26D 7/00

(52) U.S. Cl. CPC B26D 3/28; B26D 7/00; B26D 2007/005

(57) ABSTRACT

A device (13) and method for removing material (14) from a material roll (12) is disclosed. The device (13) comprises an axis (B), a movable carriage (21), at least one blade (22-24) for cutting material (14) on said material roll (12), and a material moving structure (25) for moving material (14) cut by the at least one blade (22-24). The at least one blade (22-24) and the material moving structure (25) are connected to the carriage (21) and are movable therewith in a reciprocal movement along the axis (B). The device (13) comprises at least a first blade (22) and a second blade (23), wherein the first blade (22) is displaced in relation to the second blade (23) and is arranged with a gap to the second blade (23). Disclosed is also an apparatus comprising such a device and the use of such a device for cutting material from a material roll. Optionally, the material roll can be rotated between cutting strokes of the device.

### TECHNICAL FIELD

The present invention is related to a device and method for removing material from a material roll. More specifically the present invention is related to a device for removing material from a material roll, wherein the device comprises an axis, a movable carriage, at least one blade for cutting material on said roll, and a material moving structure for moving material cut by the at least one blade, wherein the at least one blade and the material moving structure are connected to the carriage and are movable therewith in a reciprocal movement along the axis. This type of devices and methods are often used for slabbing rolls and removing residue material from material rolls. Such material rolls can comprise a core and material wound onto said core. For example, such material comprise cellulose materials, plastic materials or metal foil arranged in the form of a web material. Devices of this type are sometimes called slabbers or slabbing devices.

### BACKGROUND

In the manufacture of web materials, such as tissue and paper products, the web material is wound onto a material roll, also sometimes called a reel. Such material rolls can comprise a core onto which the web material is wound. Such material rolls can be industrial material rolls, e.g. requiring machinery for handling and transport, since such material rolls can weigh hundreds of kilograms and can have a diameter of a meter or more. Sometimes there is a need for removing material from the material roll, e.g. to remove residue material or remove the material from a damaged material roll for recycling of the material and reuse of the core.

There is a plurality of prior art solutions for removing material from industrial material rolls in the prior art. One prior art solution is disclosed in U.S. Pat. No. 6,761,098, which discloses an apparatus for removing material from a material roll, wherein the apparatus comprises a roll knife mounted on a reciprocating carriage for cutting the material on the roll. The apparatus also comprises a plough arranged to part the cut material as the carriage moves over the material roll.

One problem with prior art devices and methods for removing material from a material roll is that they can be inefficient dependent on the material on the material roll.

### SUMMARY

In view of the above one object of the present invention is to provide a device and method for removing material from a material roll that is efficient and versatile and thus usable in different situations and for different materials in an efficient manner.

The present invention is related to a device for removing material from a material roll, wherein the device comprises an axis, a movable carriage, at least one blade for cutting material on said roll, and a material moving structure for moving material cut by the at least one blade, wherein the at least one blade and the material moving structure are connected to the carriage and are movable therewith in a reciprocal movement along the axis, characterised in that the device comprises at least a first blade and a second blade, wherein the first blade is displaced in relation to the second blade in a direction perpendicular to the axis of the device and is arranged with a gap to the second blade to form a corresponding groove in the material roll. Hence, the first and second blades are spaced apart to form the groove in the material, which groove is relatively wide. The groove can also be called a channel. The combination of the plurality of radially displaced blades and the material moving structure result in an efficient removal of the material from the material roll. It has been found that the present invention efficiently removes material where layers of material in the material roll tend to adhere to each other, such as coated paper, including for example, paper coated with silicone based coatings, gloss paper and similar materials where layers tend to stick to each other. For example, the coated paper is paper that has been coated by a polymer or other materials, including kaolinite, calcium carbonate, bentonite and talc. Such coated paper is generally used in packaging industry and in magazines. The material can be calendered or supercalendered. The material can be a paper material coated with polyethylene, polyolefin extrusion coating, silicone coating, wax coating, etc. Such materials can, e.g. be used as photographic paper or to make paper cups, etc. The material can also be a plastic material. The material can also be a laminate or a foil comprising metal, such as aluminum. The device according to the present invention efficiently removes such materials from a material roll by cutting the groove in the material from one end to the opposite end of the material roll. Hence, the device can be a slabbing device, i.e. a so called slabber, to efficiently remove material from a material roll for recycling of the material and/or a core of the material roll.

The device can comprise a third blade arranged between the first and second blades, wherein the third blade is arranged with a gap to the first and second blades. It has been found that exactly three blades is particularly efficient in combination with the material moving structure for removing material that tend to adhere to itself when rolled up in a material roll. The third blade can be a central blade aligned with the material moving structure. Alternatively, the device can comprise at least three blades, optionally with one of the blades being a central blade aligned with the material moving structure. The blades can be arranged in parallel and may optionally be roller knives. The blades can have an axis of rotation perpendicular to the axis of the device and the axis of the material roll. The blades can be distributed along the axis of rotation of the blades. The blades can be arranged in axially extending, and optionally parallel, planes. The blades can be arranged to form the groove with a width of at least 20, 50, 60, 80 or 100 mm. Hence, the distance from the first blade to the second blade can be arranged with a width substantially corresponding to the width of the groove.

The material moving structure may accommodate the blades or may have a lateral extension perpendicular to the axis of the device corresponding to or being larger than the combined corresponding lateral extension of the blades. The material moving structure can comprise at least a first tapering portion for pushing material in the radial direction in relation to the axis of the device when the carriage is moved in a first direction along said axis, wherein the first tapering portion has first and second ends, wherein the second end is wider than the first end. The second end can be wider than a combined width of the blades including the gaps between them. The second end can also wider than a width of the groove, so that material beyond the groove cut by the blades is pushed to the sides by the material moving structure. The first end can be formed as an edge, optionally a cutting edge. The first tapering structure can be formed as a plough for pushing material to the sides and optionally also upwards. Hence, the material moving structure can be arranged to push material, such as material cut by the blades, to the sides and also optionally to push material in front of the device to form the groove or channel in the material roll.

The material moving structure can also comprise a second tapering portion having first and second ends, wherein the second end is wider than the first end, and wherein the second tapering portion is arranged in the opposite axial direction as the first tapering portion for pushing material in the radial direction in relation to the axis of the device when the carriage is moved in a second direction along said axis. Hence, the material moving structure can have two opposite tapering structures for pushing material in both directions when the device is moving reciprocally along the material roll.

The first end of the second tapering portion can be axially aligned with the first end of the first tapering portion, wherein the third blade is axially aligned therewith. Hence, the first end of the first tapering portion, the first end of the second tapering portion and the third blade can be aligned. Hence, in the first direction of the device, the first end of the first tapering portion can push or cut into the third cut formed by the third blade in the previous stroke of the device and push material to the sides and optionally also upwards. Similarly, in the second direction of the device, the first end of the second tapering portion can push or cut into the third cut formed by the third blade in the previous stroke and push material to the sides and optionally also upwards.

The blades can project beyond the material moving structure in a radial direction. The material moving structure has an edge, such as a lower edge, for facing the material roll, wherein the blades can project beyond said edge, such as downwards, and thus go deeper into the material roll than the material moving structure. Hence, the blades can first cut into the material, wherein, in the following stroke of the device, the material moving structure can move the cut material while the blades simultaneously cut deeper into the material.

The blades can be aligned, so that they have a common axis of rotation. Alternatively, the blades are arranged with an angle to each other, e.g. such that the blades extend in axial planes being inclined to each other. For example, the blades are arranged so that portions of the blades cutting into the material roll is arranged closer to each other than portions remote from the material roll. Alternatively, each of the blades can have its own axis of rotation, wherein said axes of rotation can be displaced in relation to each other in the axial direction. For example, one of the blades, such as the third blade can be arranged in front of the other blades when the device is moved in the first direction. Optionally, the axes of rotation of the blades can be displaced in the radial direction, so that e.g. one or more of the blades cut deeper into the material than the other blade(s). For example, the blades can be arranged with different sizes. Hence, one or more of the blades can be arranged with a greater diameter than the remaining blade(s). The blades can be arranged at an angle to each other, e.g. such that The position of the blades can be individually adjustable, e.g. in height. For example, the blades, or at least the first and second blades, are removable or arranged on an arm that can be pivoted away from a cutting position.

The present invention is also related to an apparatus for removing material from a material roll. The apparatus can be in the form of an installation. The apparatus comprises a device as set out above and a frame for supporting a material roll having an axis, wherein the frame comprises a beam supporting the device, wherein the device is movable in a reciprocal movement in the axial direction along said beam.

The material roll and/or the device is/are movable in a radial direction in relation to each other, so that the device can be brought closer to the core of the material roll and cut further layers of the material roll. For example, the apparatus can comprise one or more motors for moving the material roll and/or the device in the radial direction towards and away from each other. The apparatus can also be arranged for rotating the material roll, e.g. by means of a motor in a conventional manner. The apparatus can also comprise means for providing pressurized air to push away material cut by the blades. Such means can be arranged in a conventional manner.

As an alternative to the apparatus, the device can be arranged on an industrial robot for moving the device in the reciprocal movement I the axial direction along the material roll as well as moving the device in the radial direction closer to the core of the material roll.

The present invention is also related to a method for removing material from a material roll having an axis, comprising the steps of
a) bringing at least a first blade and a second blade of a device into contact with an outer layer of material of said material roll,
b) moving said blades in a first axial direction along the material roll by means of a movable carriage and thereby providing at least a first cut and a second cut in a radial direction into the material roll and in the axial direction along the roll,
c) after step b) moving the device and/or the material roll in the radial direction towards the other,
d) moving said blades in a second axial direction, opposite to the first axial direction, along the material roll by means of the movable carriage and thereby providing at least the first and second cuts in the radial direction further into the material roll and in the axial direction along the roll, and
e) by means of a material moving structure moving material cut by said blades.

The method can further comprise the steps of in steps b) and d) providing a third cut by means of a third blade between the first and second cuts provided by the first and second blades. The method can further comprise the step of bringing at least a first tapering portion of the material moving structure into the third cut when moving the blades in the first axial direction. Optionally the method can also comprise the step of bringing a second tapering portion of the material moving structure into the third cut when moving the blades in the second axial direction. The method can comprise the step of cutting deeper into the material by the blades than the material moving structure is moving material. The method can comprise the step of pushing material in a radial lateral direction by means of the material moving structure, and optionally also pushing material in the radial direction away from the material roll, such as upwards, by means of the material moving structure. The material moving structure can optionally push material in front of the device. The method can comprise the step of forming a groove in the material roll by means of the blades and the material moving structure. The groove can be formed with a width of at least 20, 50, 60, 80 or 100 mm. The method can include the step of rotating the material roll between at least some strokes by the device to form a plurality of parallel grooves in the material roll.

The present invention is also related to a use of the device according as set out above for cutting material from a material roll comprising a core and a web material wound onto the core. The device can be used for removing material in the form of coated paper or plastic material. The device can be used for removing material having a coating or a layer including silicone. For example, the device can be used for removing supercalendered material. For example, the device can be used for removing material, such as a laminate or a foil, comprising metal, such as aluminum.

Further objects and advantages of the present invention will be clear to a person skilled in the art when reading the detailed description below.

### BRIEF DESCRIPTION OF THE DRAWINGS

FIG. 1 is a schematic view of an apparatus according to one embodiment, comprising a material roll, a device for removing material from the material roll and a frame supporting the material roll and the device for cutting,

FIG. 2 is a schematic perspective view of the material roll and the device for removing the material without the frame and illustrating grooves cut into outer layers of the material roll by the device,

FIG. 3 is a schematic perspective view of the device according to one embodiment, illustrating a carriage, blades and a material moving structure of the device,

FIG. 4 is a schematic side view of the device of FIG. 3, illustrating the blades projecting beyond the material moving structure in a radial direction, and

FIG. 5 is a schematic view of the device of FIG. 3 seen from a cutting side thereof, illustrating the blades arranged within the material moving structure,

### DESCRIPTION OF EMBODIMENTS

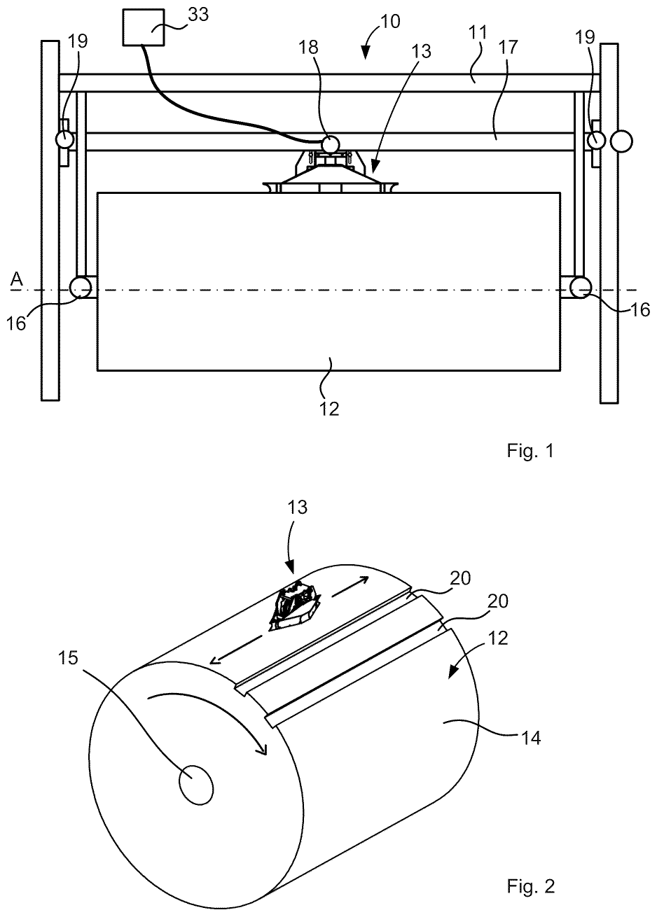

To further describe the present invention a number of embodiments thereof will be described in detail below, referring to the appended drawings. With reference to FIG. 1, an apparatus 10 comprising a frame 11 for supporting a material roll 12 and a device 13 for removing material 14 from the material roll 12 is illustrated schematically according to one embodiment. Optionally, the roll of material 12 comprises a core 15, wherein the material 14 is wound onto the core 15 in a plurality of layers. Hence, the material roll 12 comprises a plurality of layers of material 14. For example, the material 14 is a web material. According to one embodiment, the material 14 is a cellulose based and/or plastic based material. For example, the material 14 is a paper material or plastic material, optionally comprising a coating. According to one embodiment, the material roll 12 comprises a material 14 having a surface adhering to the surface of adjacent layers by the inherent properties of the material 14. The material roll 12 is an industrial material roll for use in production of other products. These rolls can weigh hundreds of kilograms and may have diameters exceeding one meter, making manual handling impractical. The material roll 12 has an axis A. The material 14 is wound around the axis A.

The apparatus 10 is arranged for removing the material 14, such as layers of wound material, from the material roll 12. For example, the apparatus 10 is arranged for removing the material 14 from the core 15. According to one embodiment, the apparatus 10 is a slabber or a slabbing apparatus for separating the material 14 from the core 15, so that the material 14 and/or the core 15 can be reused or recycled in an efficient manner. For example, the frame 11 is arranged so that the material roll 12 can be rotated around the axis A. For example, the frame 11 comprises one or more motors 16 or other conventional means for rotating the material roll 12. The frame 11 is also arranged so that the device 13 is movable in the axial direction in a reciprocating manner. For example, the device 13 is movable along the axis A in a conventional manner. In the illustrated embodiment, the frame 11 comprises a beam 17 along which the device 13 is reciprocally movable. The material roll 12 is arranged with its axis A in parallel to the beam 17, so that the beam 17 extends along the axis A and the device can be moved back and forth along the axis A in a first direction and a second direction opposite to the first direction along the material roll 12. For example, the device 13 or the beam 17 carrying the device 13 is displaceable in the axial direction in a conventional manner, such as by means of a motor 18 driving the device 13 or the beam 17, either directly or through a pneumatic cylinder or in other suitable manners.

The frame 11 is arranged so that the material roll 12 and/or the device 13 is/are movable in relation to each other in radial directions. For example, the beam 17 is displaceable in the radial direction while bringing the device 13 along therewith, so that the device 13 can be brough into contact with outer layers of the material roll 12 and also closer to the core 15, if applicable. Alternatively or in addition, the frame 11 is arranged so that the material roll 12 is radially displaceable in relation to the device 13. For example, the device 13 and/or the material roll 12 is/are movable so that the device 13 can be brought into contact with the outer layers of the material 14 and, after removal of layers of material 14, into contact with an innermost layer of the material 14 or into contact with the core 15, if applicable. For example, the device 13 and/or the material roll 12 is/are movable in the radial direction by means of one or more motors 19 in a conventional manner.

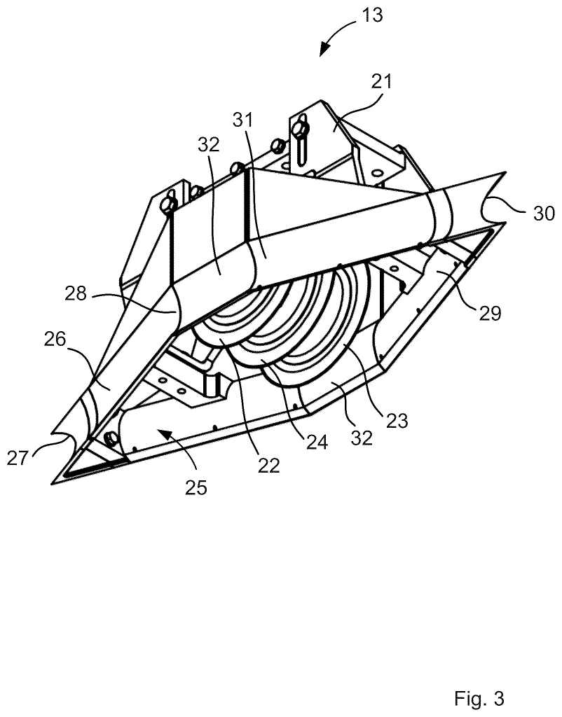

With reference particularly to FIG. 2, the device 13 is arranged for cutting grooves 20 into the material 14 of the material roll 12. The grooves 20 have opposite sides arranged at a distance from each other, i.e. with a gap between them forming a width of the grooves 20. For example, the device 13 is arranged for cutting grooves 20 having a width of at least 20 mm, 30 mm, 50 mm or 100 mm. The device 13 is arranged for cutting the grooves 20 along the entire material roll 12, from one end thereof to the opposite end thereof. For example, the device 13 is arranged for cutting a first groove 20 when moving along the axis A in the first direction and for cutting a second groove 20 spaced apart from the first groove 20 when moving in the second direction. After forming the first groove 20 in the outer layers of material 14, the material roll 12 is rotated, which is illustrated by means of the arrow at one end of the roll, wherein the second groove 20 is formed. Hence, the device 13 is arranged for making cutting strokes back and forth along the axis A, wherein the material roll 12 can be rotated after a predetermined number of cutting strokes. After cutting of the second groove 20, the material roll 2 can be rotated further for further cutting of additional grooves 20 by the device 13. Alternatively, the device 13 is arranged to move around the material roll 12 in the circumferential direction between cutting strokes back and forth along the axis A, optionally by means of an industrial robot. The cutting strokes are illustrated in FIG. 2 by means of arrows along the material roll 12.

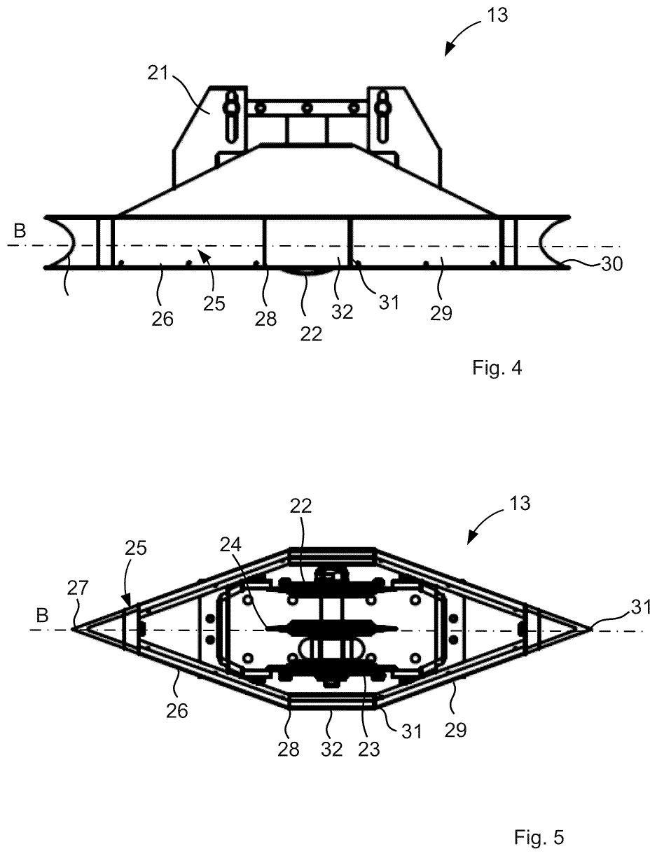

With reference to FIGS. 3-5 the device for removing material 14 from the material roll 12 is illustrated more in detail according to one embodiment. The device 13 is a cutting device for cutting layers of the material 14. The device 13 is arranged for forming one or more of the grooves 20 in the outer layers of the material 14 for removal thereof to expose further layers of the material 14 and then forming further one or more grooves in the exposed layers of the material 14 for removal thereof. The device 13 comprises an axis B, illustrated in FIG. 4. The axis B of the device 13 is arranged in parallel to the axis A of the material roll 12 when the device 13 is cutting the material 14. The device 13 comprises a movable carriage 21, a plurality of blades 22-24 and a material moving structure 25. The carriage 21 is connected to the beam 17. The carriage 21 is movable along the beam 17 in the axial direction along the axis B. For example, the carriage 21 is movable in a conventional manner, such as by means of a motor, either directly or via a pneumatic or hydraulic cylinder or similar. Alternatively, the beam 17 is movable in the axial direction while bringing the carriage 21 along therewith. The blades 22-24 are connected to the carriage 21 and move along therewith. The blades 22-24 are arranged as roller knives, which e.g. are fixed, rotating freely or driven by a motor to rotate. As can be seen particularly in FIGS. 3 and 5, the device 13 comprises a first blade 22, a second blade 23 and a third blade 24, wherein the third blade 24 is arranged between the first and second blades 22, 23. Hence, the device 13 comprises three blades 22-24, such as exactly three blades. Alternatively, the device 13 comprises at least two blades, i.e. at least the first and second blades 22, 23. The blades 22-24 are arranged next to each and are separated from each other. Hence, the blades 22-24 are spaced apart and arranged with a gap to each other in a radial direction perpendicular to the axis B. The blades 22-24 are arranged to form a plurality of cuts, such as three cuts, in the axial direction along the material roll 12. For example, the blades 22-24 are arranged in parallel. Optionally, the blades 22-24 have a common axis of rotation perpendicular to the axis B. For example, the blades 22-24 are of similar diameter, wherein the blades 22-24 are arranged for cutting in the radial direction to the same depth. In the illustrated embodiment, the device 13 is arranged for cutting three parallel cuts in the material 14 of the material roll 12. For example, a distance between the first and third blades 22, 24 is similar to a distance between the third and second blades 24, 23, wherein the third blade 24 is arranged centrally between the first and second blades 22, 23. The blades 22-24 are arranged in axially extending planes, optionally said planes extending in parallel.

The material moving structure 25 is arranged for moving material 14 cut by the blades 22-24. The material moving structure 25 comprises a first tapering portion 26 for pushing material in the radial direction in relation to the axis B of the device 13 when the device 13 is moved in a first direction along said axis B. The first tapering portion 26 has first 27 and second ends 28, wherein the second end 28 is wider than the first end 27. For example, the first end 27 is formed as an edge, such as a cutting edge. The first tapering portion 26 is arranged for pushing material 14 in the lateral direction in relation to the axis B. Hence, the material moving structure 25 is arranged for parting the cut material. Optionally, the first end 27 of the tapering portion 26 is also arranged for pushing material 14 in the radial direction away from the material roll 12 (such as upward) and axially in the moving direction of the device 13. For example, the first tapering portion 26 is arranged as a wedge or as a plough. For example, the first tapering portion 26 is V-shaped having two interconnected walls arranged at an angle to each other. For example, the blades 22-24 are arranged at the second end 28, optionally within the width thereof. Optionally, the first tapering portion 26 is V-shaped and the blades 22-24 are arranged within or partially within the V-shaped first tapering portion. Alternatively, the blades 22-24 are arranged behind the first tapering portion.

In the illustrated embodiment, the material moving structure 25 also comprises a second tapering portion 29 having first and second ends 30, 31, wherein the second end 31 is wider than the first end 30 in a similar manner as the first tapering portion 26. For example, the second tapering portion 29 is arranged in a similar manner as the first tapering portion 26. The second tapering portion 29 is arranged in the opposite axial direction as the first tapering portion 26 for pushing material 14 in the radial direction in relation to the axis B of the device 13 when moving in the second direction along said axis B. Hence, the material moving structure 25 is arranged for moving material 14 in both directions as the device is moving reciprocally along the axis A of the material roll 12. For example, the first and second material moving structures 25, 29 are arranged as opposite wedges or ploughs. For example, the material moving structure 25 is formed as a first plough and an opposite second plough, wherein the blades 22-24 are arranged between the first and second ploughs. The blades 22-24 are arranged between the first and second tapering portions 26, 29 and within the widths of the second ends 28, 31 thereof. In the illustrated embodiment, the material moving structure 25 also comprises sides 32 connecting the second ends 28, 31 of the first and second tapering portions 26, 29. For example, the sides 32 connect the walls of the V-shaped first and second tapering portions 26, 29. The blades 22-24 are optionally arranged between the sides 32. Hence, the material moving structure 25 is formed as a housing accommodating the blades 22-24, wherein the blades 22-24 are arranged within the housing in the radial and lateral direction in relation to the axis B. For example, the material moving structure 25 is wider than the distance between the first and second blades 22, 23, so that the second ends 27, 31 of the first and second tapering portions 26, 29 is pushing material 14 radially beyond the cuts by the first and second blades 22, 23.

As can be seen particularly in FIG. 4, the blades 22-24 project in the radial direction in relation to the material moving structure 25. The blades 22-24 project beyond the material moving structure 25, so that the blades 22-24 can cut into the material 14 before the material moving structure 25 contacts the material 14 or so that the blades 22-24 cut deeper into the material 14 than the material moving structure 25. Optionally, the position of the blades 22-24 in relation to the material moving structure is adjustable

With reference particularly to FIG. 5, the first and second tapering portions 26, 29 are aligned in the axial direction and are also aligned with the third blade 24. Hence, the first end 27 of the first tapering portion, the third blade 24 and the first end 30 of the second tapering portion are aligned. Hence, when formed as an edge the first end 27 of the first tapering portion 26 will enter the cut formed by the third blade 24 when the device 13 is moving in the first direction, wherein the first end 30 of the second tapering portion 29 will enter the cut formed by the third blade 24 when the device 13 is moving in the second direction to force the material 14 apart and optionally also away from the material roll 12 in the radial direction (such as upward). The material moving structure 25 is also arranged for pushing material 14 radially beyond the first and second blades 22,23 in the lateral direction, i.e. beyond the sides of the grooves 20 illustrated in FIG. 2. Hence, the device 13 is configured for forming the grooves 20 and also to part, and optionally also lift, the material adjacent and along the grooves 20. The device 13 can be fed progressively radially inward towards the core 15 during operation to remove all material 14 from the core 15. Alternatively, the material roll 12 is moved towards the device 13 in the radial direction.

Optionally, the operation of the device 13 or the entire apparatus 10 is controlled by a control device 33. For example, the operation is automated by means of the control device 33.

1. A device for removing material from a material roll, wherein the device comprises:
an axis, a movable carriage, at least one blade for cutting material on said material roll, and a material moving structure for moving material cut by the at least one blade, wherein the at least one blade and the material moving structure are connected to the carriage and are movable therewith in a reciprocal movement along the axis,
wherein:
the device further comprises at least a first blade and a second blade, and
the first blade is displaced in relation to the second blade in a direction perpendicular to the axis and is arranged with a gap to the second blade to form a corresponding groove in the material roll.

2. The device according to claim 1, wherein the device comprises a third blade arranged between the first and second blades, wherein the third blade is arranged with a gap to the first and second blades.

3. The device according to claim 1, wherein the blades are arranged to provide parallel cuts in the material roll.

4. The device according to claim 1, wherein the blades are roller knives.

5. The device according to claim 1, wherein the material moving structure comprises at least a first tapering portion for pushing material in a radial direction in relation to the axis of the device when the carriage is moved in a first direction along said axis, wherein the first tapering portion has first and second ends, wherein the second end is wider than the first end.

6. The device according to claim 5, wherein the material moving structure comprises a second tapering portion having first and second ends, wherein the second end is wider than the first end, and wherein the second tapering portion is arranged in the opposite axial direction as the first tapering portion for pushing material in the radial direction in relation to the axis of the device when the carriage is moved in a second direction along said axis.

7. The device according to claim 6, wherein the first end of the second tapering portion is axially aligned with the first end of the first tapering portion.

8. The device according to claim 2, wherein the third blade is aligned with the material moving structure in the axial direction.

9. The device according to claim 1, wherein the material moving structure is formed as a first plough and an opposite second plough, wherein the blades are arranged between the first and second ploughs.

10. The device according to claim 1, wherein the blades are arranged in axially extending planes and project beyond the material moving structure in at least one direction in said planes.

11. An apparatus comprising the device according to claim 1 and a frame for supporting a material roll having an axis, wherein the frame comprises a beam supporting the device, wherein the device is movable in a reciprocal movement in the axial direction along said beam.

12. The apparatus according to claim 11, wherein one of or both of the material roll and the device is/are movable in a radial direction in relation to the other.

13. A method for removing material from a material roll having an axis, comprising the steps of
a) bringing at least a first blade and a second blade of a device into contact with an outer layer of material of said material roll, wherein the first blade is arranged with a gap to the second blade in a direction perpendicular to the axis,
b) moving said blades in a first axial direction along the material roll by means of a movable carriage and thereby providing at least a first cut and a second cut in a radial direction into the material roll and in the axial direction along the roll, and
c) by means of a material moving structure moving material cut by said blades and thereby form a first groove in the material roll.

14. The method of claim 13, comprising the step of, after step b) or c), moving the device or the material roll in the radial direction towards the other.

15. The method of claim 13, comprising the step of, after step b) or c), moving said blades in a second axial direction, opposite to the first axial direction, along the material roll by means of the movable carriage.

16. The method of claim 13, comprising the step of, in step b), providing a third cut by means of a third blade between the first and second cuts provided by the first and second blades.

17. The method of claim 16, comprising the step of bringing at least a first tapering portion of the material moving structure into the third cut when moving the blades in the first axial direction.

18. The method of claim 13, comprising the step of providing the cuts in parallel.

19. The method of claim 13, comprising the step of, after step b) or c), rotating the material roll.

20. The method of claim 13, comprising the step of arranging a second groove in the material roll, wherein the second groove is formed in parallel to the first groove.
